(19) United States
(12) Patent Application Publication
(10) Pub. No.: US 2008/0144179 A1
(43) Pub. Date: Jun. 19, 2008

(54) OPTICAL ELEMENT

(75) Inventors: Koji MIMURA, Kawasaki (JP); Ken Sumiyoshi, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kawasaki (JP)

(21) Appl. No.: 11/866,763

(22) Filed: Oct. 3, 2007

(30) Foreign Application Priority Data
Oct. 23, 2006 (JP) 2006-287694

(51) Int. Cl. G02B 5/02

(52) U.S. Cl. 359/599; 359/894

(57) ABSTRACT

An optical element includes a microlouver including transparent layers and light absorbing layers alternately disposed, the light absorbing layers constraining the extent of the direction in which light passing through the transparent layers exits, and a diffusion layer provided on the microlouver. The angle of the field of view varies in such a way that the angle of the field of the view light passing thorough the peripheral area of the optical element is smaller than the angle of the field of view of light passing thorough the central area of the optical element.

This application is based upon and claims the benefit of priority from Japanese Patent Application No. 2006-287694 filed on Oct. 23, 2006, the content of which is incorporated by reference.

### BACKGROUND OF THE INVENTION

1. Field of the Invention

The present invention relates to an optical element including a microlouver that constrains the extent of the direction of exiting transmitted light. The present invention further relates to an illumination optical device using such an optical element and a display device, represented by a liquid crystal display (LCD) and a plasma display, using such an optical element.

2. Description of the Related Art

Liquid crystal displays are used as the display devices of various information processing devices, such as mobile phones, personal digital assistances (PDAs), automatic teller machines (ATMs), and personal computers. In recent years, there have been commercialized liquid crystal displays in which the angle of the field of view is large.

When a plurality of viewers look at a single display screen, it is effective to use a liquid crystal display in which the angle of the field of view is large. However, in a device designed to be used by an individual, such as a mobile phone, a large angle of the field of view may allow others to peep at displayed information, which may be unpleasant to the user of the device. In an information processing terminal designed to be used by an indefinite number of users, when highly confidential information, such as personal information, is displayed, it is necessary to prevent others from peeping at the displayed information. There has therefore been provided a liquid crystal display capable of switching between a display mode of a narrow field of view and a display mode of a wide field of view. A liquid crystal display of this type is disclosed in JP10-197844A.

FIG. 1 shows an example of a liquid crystal display associated with the present invention and capable of switching between a display mode of a narrow field of view and a display mode of a wide field of view. Referring to FIG. 1, the liquid crystal display includes display panel 100 formed of a plurality of pixels arranged in a matrix and microlouver 101 attached onto display panel 100. Microlouver 101 has a periodic structure in which light absorbing layers 102 and transparent layers 103 are alternately disposed at a fixed pitch, as shown in FIG. 2. Transparent layers 103 only transmit light incident at an angle of the field of view that is θ or smaller. The light incident at an angle larger than the angle of the field of view θ is absorbed in light absorbing layers 102. The angle of the field of view θ is determined by thickness D of the periodic structure and width S of transparent layer 103. The smaller the angle of the field of view θ, the higher the directivity of the light passing through microlouver 101.

In the display mode of a narrow field of view, display panel 100 is used with microlouver 101 attached thereon. Microlouver 101 constrains the maximum angle of the field of view of the light from display panel 100. On the other hand, in the display mode of a wide field of view, display panel 100 is used with microlouver 101 removed therefrom. In this case, the maximum angle of the field of view is determined by the angle of the field of view of display panel 100 itself.

JP11-285705A discloses a technology in which the extent of exiting light is reduced from the central area toward the peripheral area of the panel by reducing the width of the opaque portion of the microlouver from the central area toward the peripheral area.

The microlouver described above has a periodic structure with a fixed periodicity across its surface to provide a uniform light blocking capability. When the display screen to which such a microlouver is attached is viewed obliquely from a position in front of the display screen, as shown in FIG. 3A, the viewing angle at one end of the screen differs from the viewing angle at the other end. In the example shown in FIG. 3A, viewing angle θR at the right end of the screen is smaller than viewing angle θL at the left end of the screen.

Now, let the viewing angle be zero when the display screen is viewed from a position in front of the display screen and let the light transmittance of the microlouver at this position be the highest as shown in FIG. 3B. The light transmittance gradually decreases as the viewing angle increases, and when the viewing angle becomes a certain value, the light transmittance becomes zero and remains zero for viewing angles larger than that value. In the example shown in FIG. 3A, the light transmittance is zero at viewing angle θL at the left end of the screen, so that the display screen is not visible. On the other hand, the light transmittance is still large, that is, slightly smaller than the highest value, at viewing angle θR at the right end of the screen, so that the display screen is visible. Therefore, even when the microlouver is attached onto the display screen, the right end of the display screen is disadvantageously visible when viewed obliquely from a position in front of the display screen.

### SUMMARY OF THE INVENTION

An exemplary object of the present invention is to provide an optical element that can prevent the entire display screen from being visible when viewed obliquely from a position in front of the display screen.

According to an exemplary aspect of the present invention, an optical element includes a microlouver including transparent layers and light absorbing layers alternately disposed, the light absorbing layers constraining the extent of the direction in which the light passing through the transparent layers exits, and a diffusion layer provided on the microlouver. The angle of the field of view of the light passing thorough the optical element changes in such a way that the angle of the field of view is smaller in the peripheral area of the optical element than that in the central area of the optical element.

According to another aspect of the present invention, an optical element includes a microlouver including transparent layers and light absorbing layers alternately disposed, the light absorbing layers constraining the extent of the direction in which the light passing through the transparent layers exits, and a diffusion layer provided on the microlouver. The diffusion power of the diffusion layer is lower in the peripheral area of the optical element than that in the central area of the optical element.

The above and other objects, features and advantages of the present invention will become apparent from the following description with reference to the accompanying drawings which illustrate examples of the present invention.

### BRIEF DESCRIPTION OF THE DRAWINGS

FIG. 1 is a schematic view showing an example of a liquid crystal display which is relevant to the present invention and capable of switching between a display mode of a narrow field of view and a display mode of a wide field of view;

FIG. 2 is a schematic view showing the configuration of the microlouver shown in FIG. 1;

FIGS. 3A and 3B are schematic views for explaining viewing angles at both ends of a screen;

FIG. 4 is a cross-sectional view showing the optical element according to a first exemplary embodiment of the present invention;

FIG. 5 is a plan view of the microlouver shown in FIG. 4;

FIG. 6 is a schematic view showing the viewing angle when the viewer is located in a position outside the area in front of the screen of a display device;

FIG. 7 is a schematic view showing the viewing angle when the viewer is located in a position in front of the screen of the display device;

FIGS. 8A and 8B show the relationship between the screen size and the viewing angle when the viewer is located in a position outside the area in front of the screen of the display device;

FIGS. 9A and 9B show the relationship between the screen size and the viewing angle when the viewer is located in a position in front of the screen of the display device;

FIG. 10 shows the relationship between the position on the screen at which the viewer looks and the light transmittance when the viewer is located at a position in front of the center of the screen of the display device having a screen size of 15 inches and, dz, the distance from the screen to the viewer in the direction of a normal to the screen, is 60 cm;

FIGS. 11A to 11F show a method for producing the microlouver shown in FIG. 4;

FIGS. 12A to 12E show another method for producing the microlouver shown in FIG. 4;

FIG. 13 shows another method for producing the microlouver shown in FIG. 4;

FIG. 14 shows another method for producing the microlouver shown in FIG. 4;

FIG. 15 is a cross-sectional view showing the optical element according to a second exemplary embodiment of the present invention;

FIGS. 16A to 16D show various microlouvers applicable to the optical element of the present invention;

FIG. 17A is a schematic view showing the configuration of a first illumination optical device on which the microlouver of the present invention is mounted;

FIG. 17B is a plan view of a prism sheet that is a component of the illumination optical device shown in FIG. 17A;

FIG. 18 is a schematic view showing a variation of the first illumination optical device shown in FIG. 17A;

FIG. 19 is a schematic view showing the configuration of a second illumination optical device on which the microlouver of the present invention is mounted;

FIG. 20 is a schematic view showing the configuration of a display device in which the microlouver of the present invention is provided on the display screen;

FIG. 21 is a schematic view showing the configuration of a first display device in which the microlouver of the present invention is mounted;

FIG. 22 is a schematic view showing the configuration of a second display device in which the microlouver of the present invention is mounted;

FIG. 23 is a schematic view showing the configuration of a third display device in which the microlouver of the present invention is mounted; and

FIG. 24 is a schematic view showing the configuration of a fourth display device in which the microlouver of the present invention is mounted.

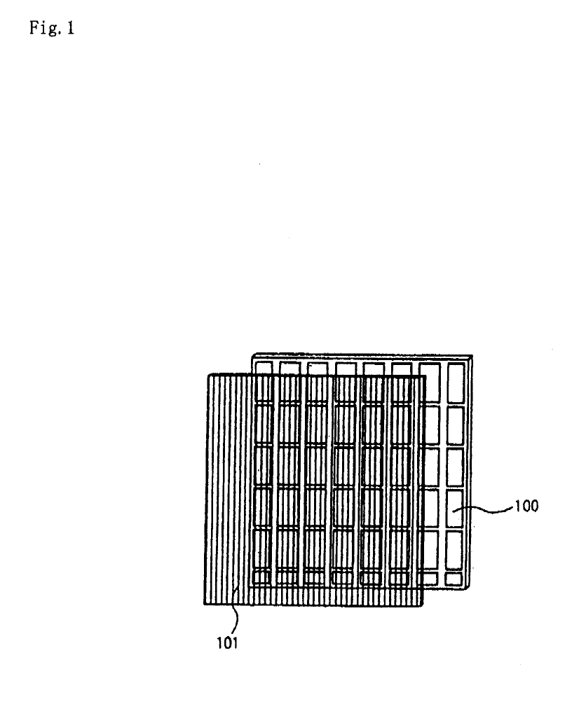

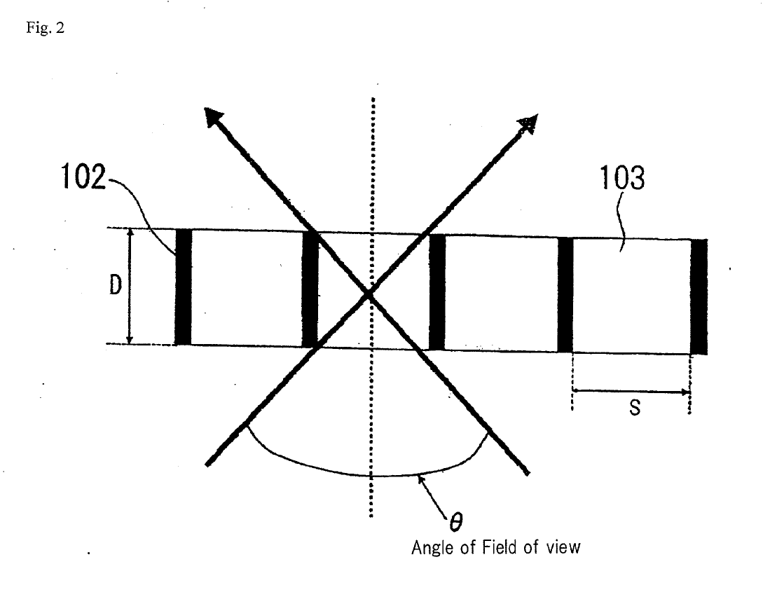

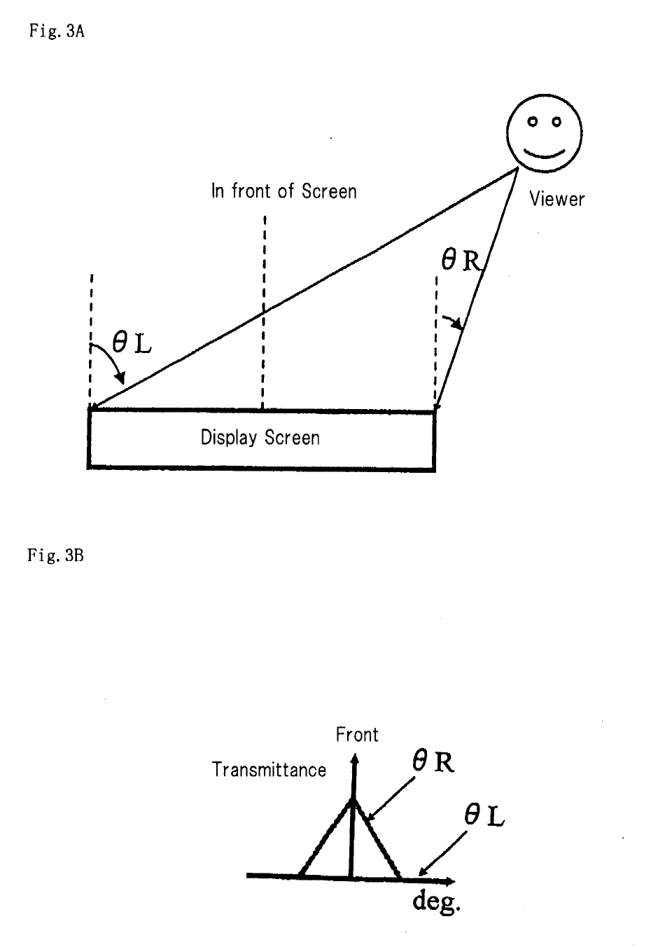

### DESCRIPTION OF THE EXEMPLARY EMBODIMENTS

### First Exemplary Embodiment

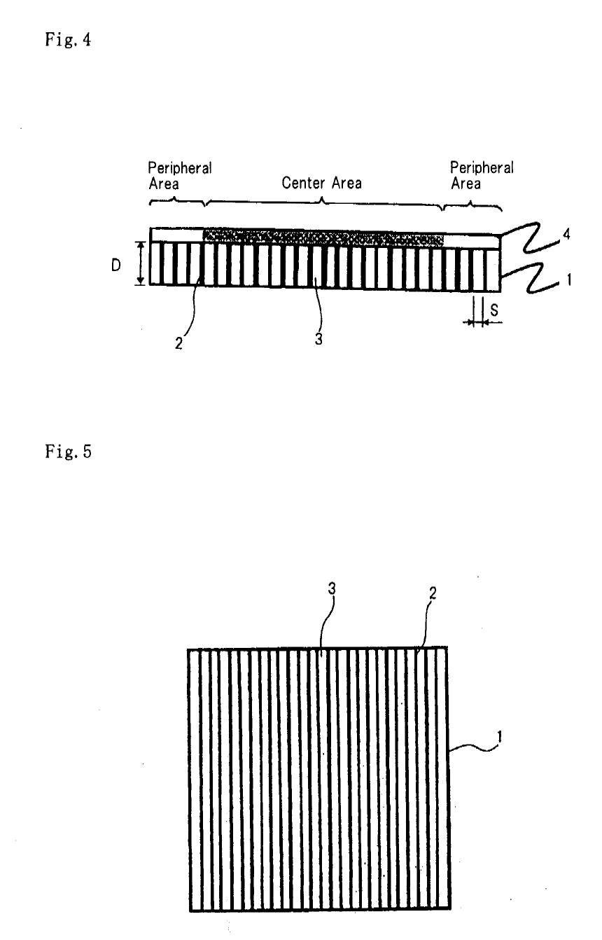

FIG. 4 is a cross-sectional view showing the optical element according to a first exemplary embodiment of the present invention. FIG. 5 is a plan view of the microlouver shown in FIG. 4.

The optical element of this exemplary embodiment includes microlouver 1 having a periodic structure in which linear light absorbing layers 2 and linear transparent layers 3 are alternately disposed in one direction, and diffusion layer 4 attached onto microlouver 1. In microlouver 1 in this exemplary embodiment, light absorbing layer 2 and transparent layer 3 are periodically disposed at a fixed pitch. Furthermore, in microlouver 1 of this exemplary embodiment, the ratio of width S of transparent layer 3 to thickness D of microlouver 1 is smaller than that of a typical microlouver. Therefore, across microlouver 1 in this exemplary embodiment, the angle of the field of view of the light passing through transparent layers 3 is smaller than that in a typical microlouver. Transparent substrates (not shown) are laminated on both sides of microlouver 1.

Diffusion layer 4 in this exemplary embodiment is configured in such a way that the diffusion power in the peripheral area of the optical element is lower than that in the central area in the right-left direction in FIGS. 4 and 5.

Specifically, a holographic diffuser can be used as diffusion layer 4. A holographic diffuser can be obtained by forming a non-periodic pattern of irregularities having a height on the order of 5 μm on a substrate, and the power of diffusing transmitted light can be set by changing the density of the pattern of irregularities.

The diffusion power is defined as the angle at which one-half the highest brightness is provided and expressed in a full angle. The angle of the field of view of the light passing through diffusion layer 4 is determined by the following approximation:

{(the angle of divergence of the light passing through the microlouver)²+(the diffusion power of the diffusion layer)²}^{1/2}

Therefore, by varying the density of the pattern of irregularities from the central area toward the peripheral area of the optical element to reduce the diffusion power, that is, to reduce haze, the angle of the field of view of the light passing through diffusion layer 4 is large in the central area while smaller in the peripheral area. In this regard, the optical element of this exemplary embodiment in which the width of the opaque section of the microlouver becomes smaller from the center toward the edge is different from the technology disclosed in JP11-285705A in which the extent of exiting light becomes smaller from the central area toward the peripheral area of the panel.

Therefore, in the optical element of this exemplary embodiment, the angle of the field of view of the light passing through microlouver 1 and diffusion layer 4 varies in one direction on the optical element in such a way that the angle of the field of view is large in the central area while smaller in the peripheral area.

Although diffusion layer 4 has been described with reference to a holographic diffuser, diffusion layer 4 is not limited thereto. For example, diffusion layer 4 may be the one obtained by embedding transparent beads or the like in a transparent layer and by varying the amount of embedded beads location-to-location to change the diffusion power for each location.

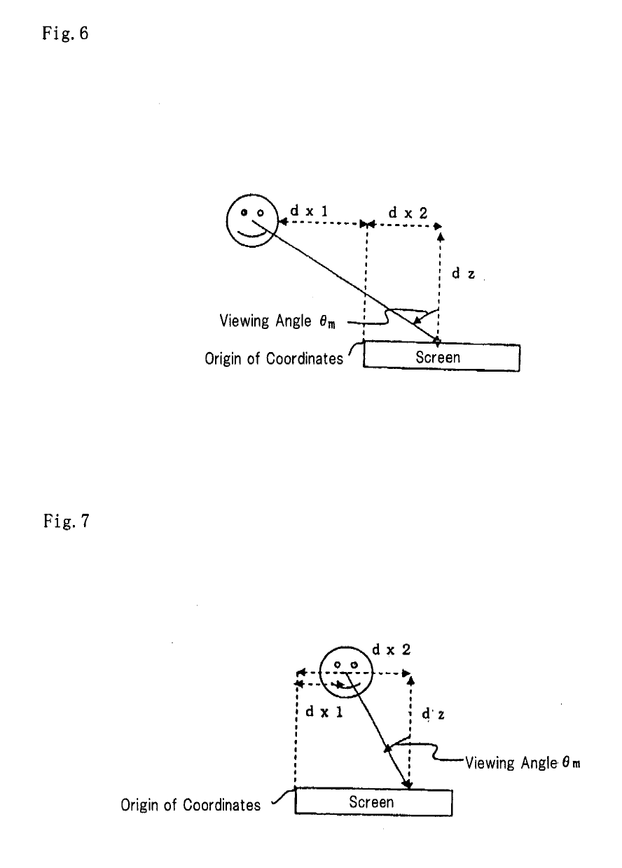

The relationship between the angle of the field of view in the optical element of this exemplary embodiment and the viewing angle when the viewer looks at a display device provided with the optical element will be described with reference to FIGS. 6 to 9B.

First, the viewing angle when the viewer looks at a display device provided with the optical element will be described with reference to FIGS. 6 and 7. FIG. 6 shows the viewing angle when the viewer is located in a position outside the area in front of the screen of the display device, while FIG. 7 shows the viewing angle when the viewer is located in a position in front of the screen of the display device.

In FIG. 6, dx1 is the distance from the end of the screen to the viewer in the direction parallel to the screen; dx2 is the distance from the end of the screen to the position on the screen at which the viewer looks in the direction parallel to the screen; dz is the distance from the screen to the viewer in the direction of a normal to the screen. When the viewer is located in a position outside the area in front of the screen of the display device, viewing angle θm when the viewer looks at the screen is expressed by the following equation (1):

θm=tan⁻¹((dx1+dx2)/dz) (1)

On the other hand, when the viewer is located in a position in front of the screen of the display device as shown in FIG. 7, viewing angle θm when the viewer looks at the portion of the screen to the right of the viewer, as shown in the figure, is expressed by the following equation (2):

θm=tan¹((dx2−dx1)/dz) (2)

When the viewer is located in a position in front of the screen of the display device, as shown in FIG. 7, viewing angle θm when the viewer looks at the portion of the screen to the left of the viewer, as shown in the figure, is expressed by the following equation (3):

θm=tan⁻¹(dx1/dz) (3)

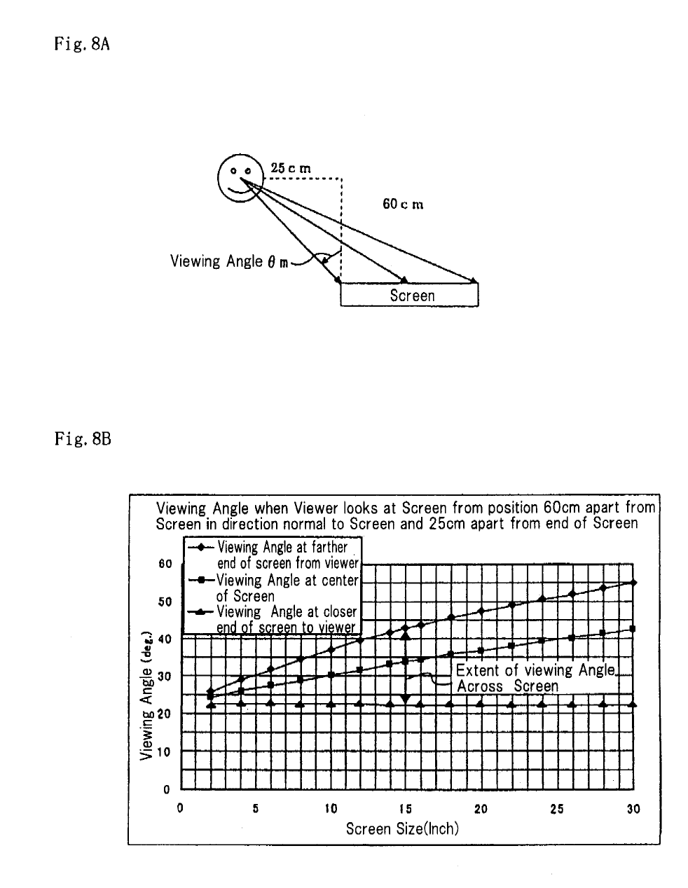

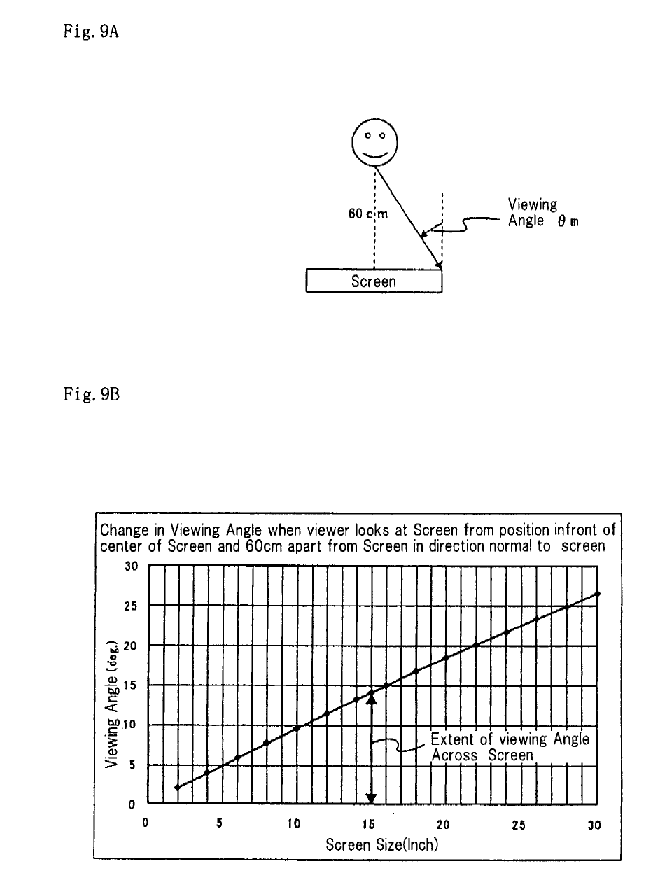

Next, the relationship between the size of the screen which the viewer looks at and the viewing angle will be described with reference to FIGS. 8A to 9B. FIGS. 8A and 8B show the relationship between the screen size and the viewing angle when the viewer is located in a position outside the area in front of the screen of the display device. FIGS. 9A and 9B show the relationship between the screen size and the viewing angle when the viewer is located in a position in front of the screen of the display device.

In FIG. 8A where the viewer is located in a position outside the area in front of the screen of the display device, dx1, the distance from the end of the screen to the viewer in the direction parallel to the screen, is 25 cm, and dz, the distance from the screen to the viewer in the direction normal to the screen, is 60 cm. FIG. 8B shows the relationship between the screen size and the viewing angle under such conditions.

Referring to FIG. 8B, viewing angle θm at the end of the screen closer to the viewer remains unchanged independent of the screen size, approximately 23 degrees. Viewing angle θm at the center of the screen is approximately 30 degrees when the screen size is 10 inches, approximately 34 degrees when the screen size is 15 inches, and approximately 37 degrees when the screen size is 20 inches. Viewing angle θm at the end of the screen farther from the viewer is approximately 37 degrees when the screen size is 10 inches, approximately 43 degrees when the screen size is 15 inches, and approximately 48 degrees when the screen size is 20 inches. It is thus understood that the viewing angles at the center of the screen and at the end of the screen farther from the viewer increase as the screen size increases.

Now, consider a case where the screen size is 15 inches. Since the viewing angle at the end of the screen closer to the viewer is approximately 23 degrees, setting the angle of the field of view at the end of the screen of the display device to approximately ±20 degrees can prevent the viewer from looking at the displayed image at the end of the screen of the display device. Furthermore, since the viewing angle at the center of the screen is approximately 34 degrees, setting the angle of the field of view at the center of the screen of the display device to approximately ±30 degrees can prevent the viewer from looking at the displayed image at the center of the screen of the display device. Therefore, when the screen size is 15 inches, by configuring the optical element in such a way that the angle of the field of view in the center area is set to approximately ±30 degrees and the angle of the field of view in the peripheral area is set to approximately ±20 degrees, the entire screen becomes invisible when the display screen is viewed from the position shown in FIG. 8A.

In FIG. 9A where the viewer is located in front of the center of the screen of the display device, dz, the distance from the screen to the viewer in the direction normal to the screen, is 60 cm. FIG. 9B shows the relationship between the screen size and the viewing angle at the end of the screen under such conditions.

Referring to FIG. 9B, it is found that viewing angle θm at the end of the screen increases with the screen size. For example, viewing angle θm is approximately 9 degrees when the screen size is 10 inches, approximately 14 degrees when the screen size is 15 inches, and approximately 18 degrees when the screen size is 20 inches. When the screen size is 15 inches and the angle of the field of view in the peripheral area of the optical element is set to approximately ±20 degrees, as described above, the angle of the field of view is greater than 14 degrees, which is the viewing angle in such a condition, so that the viewer can visually recognize the image at the end of the display screen. That is, the viewer who looks at the screen from a position in front of the screen (FIG. 9A) can visually recognize the entire image on the display screen, while the viewer who looks at the screen obliquely from a position in front of the screen (FIG. 8A) cannot visually recognize the entire image on the display screen.

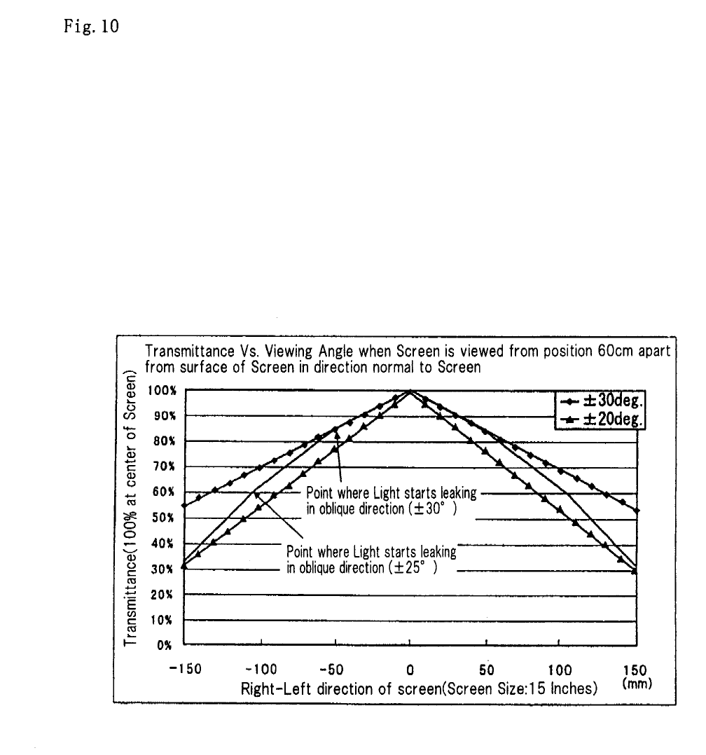

A description will now be made of the significance of varying the angle of the field of view of the light passing through microlouver 1 and diffusion layer 4 in such a way that the angle of the field of view is larger in the central area while smaller in the peripheral area as realized in the optical element of this exemplary embodiment with reference to FIG. 10. FIG. 10 shows the relationship between the position on the screen where the viewer views and the light transmittance when the viewer is located at a position in front of the center of the screen of the display device having a screen size of 15 inches, and dz, the distance from the screen to the viewer in the direction normal to the screen, is 60 cm.

When the screen size is 15 inches and the angle of the field of view in the peripheral area of the optical element is set to approximately ±20 degrees, it is possible to prevent the viewer from visually recognizing the entire image on the display screen when the viewer looks at the screen obliquely from a position in front of the screen. Therefore, when the screen size is 15 inches, by setting the angle of the field of view to approximately ±20 degrees across the optical element, it is also possible to make the image invisible when the screen is viewed obliquely from a position in front of the screen.

However, when the screen size is 15 inches and the angle of the field of view is set to approximately ±20 degrees across the optical element, the brightness uniformity within the screen disadvantageously decreases as shown in FIG. 10. On the other hand, when the angle of the field of view is set to approximately ±30 degrees across the optical element, it is possible to prevent a reduction in brightness uniformity within the screen, but it is not possible to prevent the viewer from visually recognizing the entire image on the display screen when the viewer looks at the screen obliquely from a position in front of the screen.

By varying the diffusion power of diffusion layer 4 to change the angle of the field of view of the light passing through microlouver 1 and diffusion layer 4 in such a way that the angle of the field of view is larger in the central area while smaller in the peripheral area as realized in the optical element of this exemplary embodiment, it is possible not only to prevent the reduction in brightness uniformity within the screen but also to prevent the viewer from visually recognizing the entire image on the display screen when the viewer looks at the screen obliquely from a position in front of the screen.

The variation from an angle of the field of view that is larger in the central area of the optical element toward an angle of the field of view that is smaller in the peripheral area may be stepwise or continuous.

A method for producing the microlouver of this exemplary embodiment will now be described.

FIGS. 11A to 11F show a series of steps for producing the microlouver of this exemplary embodiment. First, transparent photosensitive resin layer 51 is formed on transparent substrate 50 (FIG. 11A). Various deposition methods can be used to form transparent photosensitive resin layer 51, for example, slit die coating, wire coating and dry film transfer. As transparent photosensitive resin layer 51, a chemically amplified negative photoresist manufactured by KAYAKU Microchem Corporation (model: SU-8) can be used. This resist having a relatively small pre-exposure molecular weight significantly well dissolves in a solvent, such as cyclopentanone, propylene glycol methyl ether acetate (PEGMEA), γ-butyrolactone (GBL), and isobutyl ketone (MIBK), so that it is easy to form a thick film having a thickness of 100 to 200 μm.

Then, mask 52 is used to pattern transparent photosensitive resin layer 51 (FIG. 11B). Mask 52 has a pattern (arrangement of transparent areas and light blocking areas) corresponding to the spatial arrangement of transparent layers 3 and light absorbing layers 2 of microlouver 1. This patterning step is a well known step in photolithography, and various exposure systems, such as stepper exposure and contact exposure, can be used.

The patterning provides a pattern in which transparent layers having width S and thickness d are formed in a fixed direction at pitch P, as shown in FIG. 11C. These transparent layers become transparent layers 3 of microlouver 1. The surface of transparent substrate 50 is exposed between adjacent transparent layers 3. Thickness d is 100 to 200 μm. Width S is 40 to 70 μm. Pitch P is 50 to 90 μm. The space between adjacent transparent layers is 10 to 20 μm.

Then, the gap between adjacent transparent layers 3, which are patterned transparent photosensitive resin layers, is filled with curable material 53 (FIG. 11D). To fill curable material 53, any of squeegee- or coater-based application and filling methods is used. To prevent the curable material from being underfilled, the filling process is desirably carried out in a vacuum (in a sufficiently depressurized container).

After curable material 53 is etched to expose the surface of the transparent photosensitive resin layer, curable material 53 is cured (FIG. 11E). When no curable material is attached to the surface of the transparent photosensitive resin layer in the step of filling curable material, the etching step can be omitted.

Finally, transparent substrate 54 is attached onto the transparent photosensitive resin layer and curable material 53 (FIG. 11F). Transparent substrate 54 may be laminated onto the transparent photosensitive resin layer and curable material 53, or may be attached onto the transparent photosensitive resin layer and curable material 53 via a transparent adhesive layer. Furthermore, a hard coat layer for preventing scratches or an antireflection film may be formed on the surface of transparent substrate 54.

Another method for producing the microlouver in this exemplary embodiment will be described.

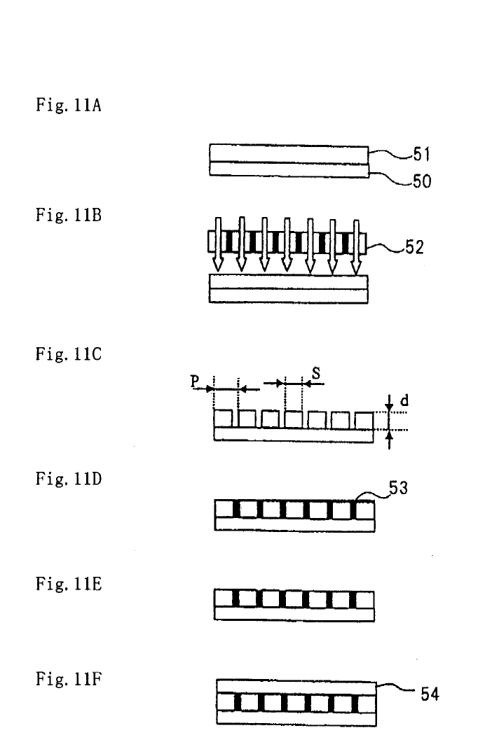

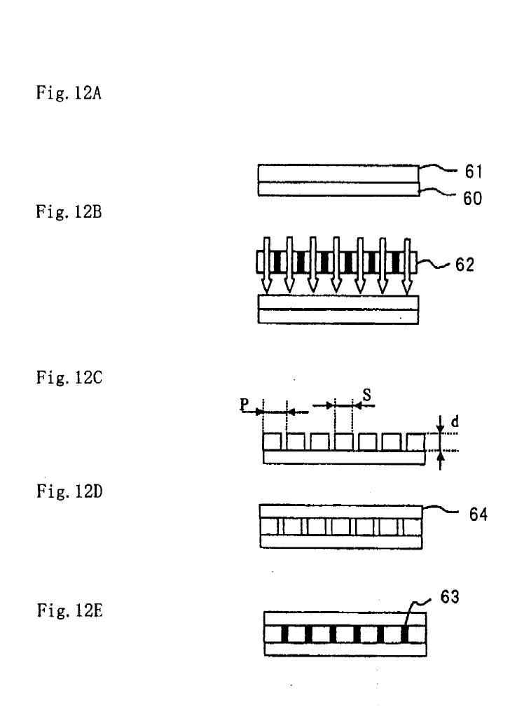

FIGS. 12A to 12E show a series of production steps of another method for producing the microlouver of the present invention. First, transparent photosensitive resin layer 61 is formed on transparent substrate 60 (FIG. 12A). Then, mask 62 is used to pattern transparent photosensitive resin layer 61 (FIG. 12B) to provide a pattern in which transparent layers having width S and thickness d are formed in a fixed direction at a pitch P, as shown in FIG. 12C. The steps described above are the same as those in FIGS. 11A to 11C.

Then, transparent substrate 64 is attached onto patterned transparent photosensitive resin layer 61 (FIG. 12D). Transparent substrate 64 is attached to transparent photosensitive resin layer 61 through pressure sintering or UV pressuring. If transparent substrate 64 does not completely come into close contact with patterned transparent photosensitive resin layer 61 in this attachment step, an adhesive layer (which may be made of the same photosensitive resin) is provided between transparent substrate 64 and patterned transparent photosensitive resin layer 61 and then the attachment step is carried out through pressure sintering or UV pressuring. In this way, transparent substrate 64 can reliably come into close contact with patterned transparent photosensitive resin layer 61.

Then, curable material 63 is injected into the gap between adjacent patterned transparent photosensitive resin layers 61 using a capillary phenomenon in the atmosphere or a vacuum atmosphere (FIG. 12E). Then, injected curable material 63 is cured through UV exposure or heat treatment, and microlouver 1 is thus completed. Curing curable material 63 allows the transparent substrate to be bonded more strongly, thus preventing defects, such as delamination of the transparent substrate. Curing curable material 63 can also prevent defects, such as leakage of the curable material. As curable material 63, solventless material is desirable. When solvent-based curable material is used, the filled solvent evaporates and hence the filled area shrinks in volume, so that the light blocking characteristics in the area filled with the curable material (light absorbing layer) become non-uniform in the whole substrate. On the other hand, solventless material can make the characteristics uniform. Unevenness of display can therefore be reduced, resulting in uniform display.

Next, another method for producing the microlouver in this exemplary embodiment will be described.

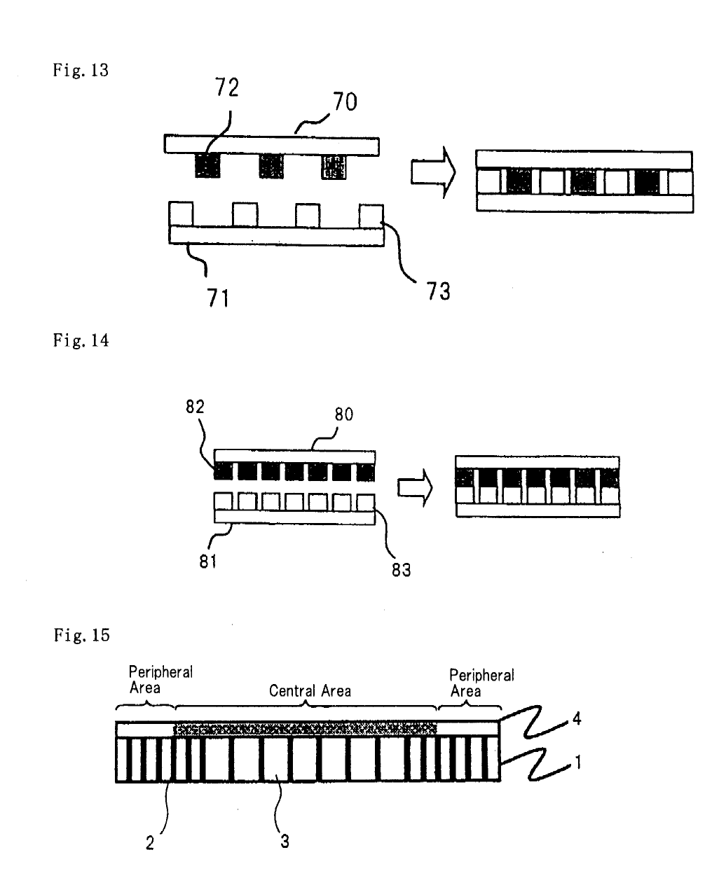

An example of other production methods is a method for producing the microlouver using the steps shown in FIG. 13. First, a transparent photosensitive resin layer is formed on each of two transparent substrates 70 and 71, and the transparent photosensitive resin layers are patterned through photolithography. Patterned transparent photosensitive resin layers 72 on transparent substrate 70 are disposed at a fixed pitch. Similarly, patterned transparent photosensitive resin layers 73 on transparent substrate 71 are disposed at the same pitch as that of transparent photosensitive resin layers 72. The width of transparent photosensitive resin layer 72 is the same as that of transparent photosensitive resin layer 73. The width of transparent photosensitive resin layers 72 and 73 is smaller than the pitch interval. Transparent photosensitive resin layers 72 and 73 are aligned and attached to each other in such a way that they are interleaved with each other. The substrate shown in FIG. 12D is thus provided. Then, curable material is injected and cured in the procedures described in the other production methods described above.

In this production method, the ratio of the width to height of the light absorbing layer can be twice the ratios obtained in the production methods described in FIGS. 11A to 11F and FIGS. 12A to 12E, allowing a louver with a smaller angle of the field of view to be produced.

The microlouver can be produced by a method using the steps shown FIG. 14. First, a transparent photosensitive resin layer is formed on each of two transparent substrates 80 and 81, and the transparent photosensitive resin layers are patterned through photolithography. Patterned transparent photosensitive resin layers 82 on transparent substrate 80 are disposed at a fixed pitch. Similarly, patterned transparent photosensitive resin layers 83 on transparent substrate 81 are disposed at the same pitch as that of transparent photosensitive resin layers 82. Transparent photosensitive resin layers 82 and 83 are arranged in the same pattern, and the width and height of transparent photosensitive resin layer 82 are the same as those of transparent photosensitive resin layer 83. Transparent photosensitive resin layers 82 and 83 are attached to each other. The substrate shown in FIG. 12D is thus provided. Then, curable material is injected and cured according to the procedures described in the other production methods described above.

Since the production methods shown in FIGS. 12A to 14 use a capillary phenomenon, the methods can be suitably applied to a periodic structure in which light absorbing layers are continuously disposed. By attaching diffusion layer 4 to microlouver 1 produced in any of the production methods described above, the optical element of this exemplary embodiment shown in FIG. 4 is formed.

### Second Exemplary Embodiment

FIG. 15 is a cross-sectional view showing the optical element according to a second exemplary embodiment of the present invention.

The optical element of this exemplary embodiment includes microlouver 1 having a periodic structure in which linear light absorbing layers 2 and linear transparent layers 3 are alternately disposed in one direction, and diffusion layer 4 attached onto microlouver 1. The width of transparent layer 3 in microlouver 1 of this exemplary embodiment is larger in the central area while smaller in the peripheral area. Therefore, in microlouver 1 in this exemplary embodiment, the angle of the field of view of the light passing through transparent layers 3 is large in the central area while smaller in the peripheral area.

Diffusion layer 4 in this exemplary embodiment is configured in such a way that the diffusion power in the peripheral area of the optical element is lower than that in the central area in the right/left direction in FIG. 15. Since the light that has passed through microlouver 1 is diffused when passing through diffusion layer 4, the angle of the field of view of the light that passed through diffusion layer 4 becomes larger according to the diffusion power of diffusion layer 4. In this exemplary embodiment, since diffusion layer 4 has a lower diffusion power in the peripheral area than the diffusion power in the central area, the angle of the field of view of the light passing through diffusion layer 4 is large in the central area while smaller in the peripheral area.

As described above, in the optical element of this exemplary embodiment, microlouver 1 having a larger angle of the field of view in the central area and a smaller angle of the field of view in the peripheral area is combined with diffusion layer 4 having a similar effect of increasing the angle of the field of view in the central area and reducing the angle of the field of view in the peripheral area. As a result, according to the optical element of this exemplary embodiment, it is possible to change the angle of the field of view of the light passing through microlouver 1 and diffusion layer 4 in one direction on the optical element in such a way that the angle of the field of view is larger in the central area while smaller in the peripheral area than those in the optical element of the first exemplary embodiment shown in FIG. 4 and the like. In this exemplary embodiment, in particular, since the width of transparent layer 3 in microlouver 1 is large in the central area while smaller in the peripheral area, the brightness of the screen in the central area can be improved, Microlouver 1 in this exemplary embodiment can be produced by using the production methods described with reference to FIGS. 11A to 14.

### Other Exemplary Embodiments

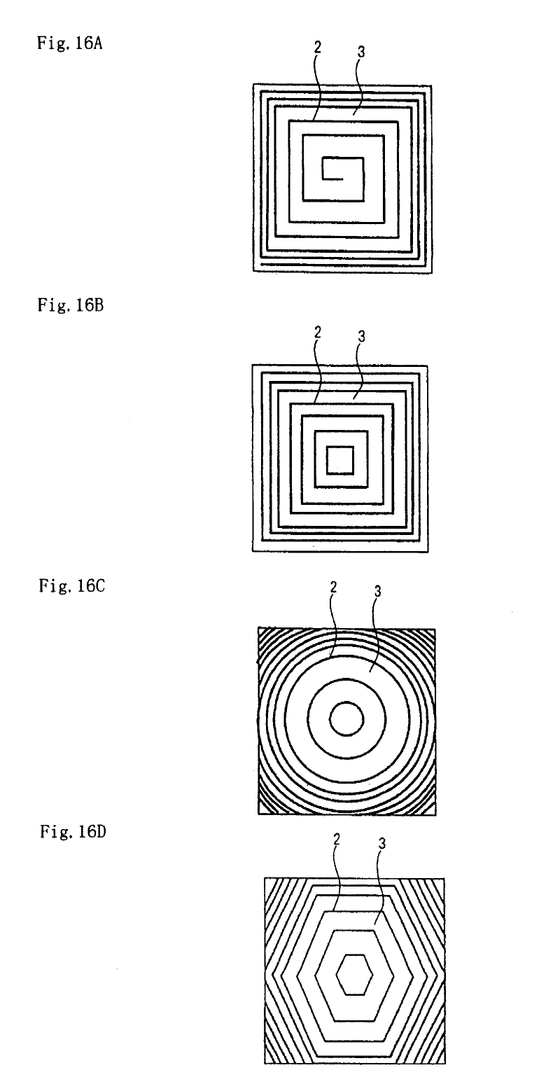

FIGS. 16A to 16D are plan views showing various microlouvers applicable to the optical element of the present invention.

The microlouver shown in FIG. 16A includes light absorbing layer 2 extending from the central area to the peripheral area in a spiral manner. The width of transparent layer 3, which is formed between adjacent portions of light absorbing layer 2, is large in the central area of the microlouver while smaller in the peripheral area than the width in the central area in any direction from the center of the microlouver toward the peripheral area. The diffusion layer (not shown) attached onto the microlouver is configured in such a way that the diffusion power in the peripheral area of the optical element is lower than the diffusion power in the central area in any direction from the center of the microlouver toward the peripheral area.

In the microlouver shown in FIG. 16B, a plurality of square light absorbing layers 2 are disposed in a concentric manner. The width of transparent layer 3 between adjacent square light absorbing layers 2 is large in the central area of the microlouver while smaller in the peripheral area than the width in the central area in any direction from the center of the microlouver toward the peripheral area. The diffusion layer (not shown) attached onto the microlouver is configured in such a way that the diffusion power in the peripheral area of the optical element is lower than the diffusion power in the central area in any direction from the center of the microlouver toward the peripheral area.

In the microlouver shown in FIG. 16C, a plurality of circular light absorbing layers 2 are disposed in a concentric manner. The width of transparent layer 3 between adjacent circular light absorbing layers 2 is large in the central area of the microlouver while smaller in the peripheral area than the width in the central area in any direction from the center of the microlouver toward the peripheral area. The diffusion layer (not shown) attached onto the microlouver is configured in such a way that the diffusion power in the peripheral area of the optical element is lower than the diffusion power in the central area in any direction from the center of the microlouver toward the peripheral area.

In the microlouver shown in FIG. 16D, a plurality of hexagonal light absorbing layers 2 are disposed in a concentric manner. The width of transparent layer 3 between adjacent hexagonal light absorbing layers 2 is large in the central area of the microlouver while smaller in the peripheral area than the width in the central area in any direction from the center of the microlouver toward the peripheral area. The diffusion layer (not shown) attached onto the microlouver is configured in such a way that the diffusion power in the peripheral area of the optical element is lower than the diffusion power in the central area in any direction from the center of the microlouver toward the peripheral area.

Although FIGS. 16A to 16D show microlouvers including light absorbing layers 2 having various shapes, the shape of light absorbing layer 2 that the microlouver can include is not limited to these examples. For example, the microlouver may include a circularly spiral light absorbing layer 2 instead of light absorbing layer 2 having the shape shown in FIG. 16A. Alternatively, light absorbing layers 2 having the shapes shown in FIGS. 16B to 16D may be replaced with light absorbing layers 2 having rectangular, elliptical or other polygonal shapes.

Although FIGS. 16A to 16D show microlouvers in which the width of transparent layer 3 between adjacent portions of light absorbing layer 2 is larger in the central area of the microlouver while smaller in the peripheral area than the width in the central area in any direction from the center of the microlouver toward the peripheral area, each of the microlouvers may be configured in such a way that the width of transparent layer 3 is equal across the microlouver. Even in such a configuration, the diffusion layer (not shown) attached onto the microlouver is configured in such a way that the diffusion power in the peripheral area of the optical element is lower than the diffusion power in the central area in any direction from the center of the microlouver toward the peripheral area. Therefore, in the optical element including any of these microlouvers, the angle of the field of view of the light passing through the optical element changes in such a way that the angle of the field of view is smaller in the peripheral area of the optical element than that in the central area of the optical element.

The microlouvers in this exemplary embodiment can be produced by using the production method described with reference to FIGS. 11A to 11F. Furthermore, the microlouvers in this exemplary embodiment can be produced by using the production methods described with reference to FIGS. 12A to 14 as long as the light absorbing layers are connected as shown in FIG. 16A.

According to the optical element including any of various microlouvers and diffusion layers described above, it is possible to change the angle of the field of view of the light passing through the microlouver and the diffusion layer in such a way that the angle of the field of view is large in the central area while smaller in the peripheral area in any direction from the center of the optical element toward the peripheral area (at least in two directions intersecting each other on the optical element). Therefore, when a display screen provided with the optical element is viewed obliquely from any position in front of the display screen, it is possible to prevent the viewer from visually recognizing the entire image on the display screen.

The optical element of the present invention described above is applicable not only to liquid crystal displays but also to other display devices, for example, luminous display devices, such as plasma displays and electroluminescence displays.

Various conceivable usage of the optical element of the present invention may be the optical element mounted on an illumination optical device, the optical element directly attached to the surface of a display panel, the optical element mounted in a display device and the like. Specific configurations in such usage will be described below.

(1) First, an illumination optical device on which the optical element of the present invention is mounted will be described.

### [First Illumination Optical Device]

FIG. 17A shows the configuration of a first illumination optical device on which the optical element of the present invention is mounted. Referring to FIG. 17A, the first illumination optical device includes a planar light source and optical element 20. The planar light source includes light source 21, represented by a cold cathode tube, reflective sheet 22, light guide plate 23, diffuser plate 24, and prism sheets 25a and 25b, each formed of an array of prisms. Optical element 20 is formed of any of the optical elements in the exemplary embodiments described above.

Light guide plate 23 is made of acrylic resin or the like and configured in such a way that the light from light source 21 is incident on one end of light guide plate 23 and in such a way that the incident light propagates through the light guide plate and uniformly exits from the front surface (predetermined side surface). Reflective sheet 22 is provided on the rear side of light guide plate 23 and reflects light that exits from the rear surface of light guide plate 23 in the front surface direction. Although not shown in the figure, reflection means is provided also on the other end and side surfaces of light guide plate 23.

The light that exits from the front surface of light guide plate 23 is incident on optical element 20 via diffuser plate 24 and prism sheets 25a and 25b, each formed of an array of prisms. Diffuser plate 24 diffuses the light incident from light guide plate 23. The brightness of the light that exits from the right end of light guide plate 23 differs from the brightness of the light that exits from the left end because of the structure of light guide plate 23. To address this problem, light from light guide plate 23 is diffused in diffuser plate 24.

Prism sheets 25a and 25b improve the brightness of the light incident from light guide plate 23 via diffuser plate 24. Prism sheet 25a is formed of a plurality of prisms disposed in a fixed direction at a fixed pitch, as shown in FIG. 17B. Prism sheet 25b has the same configuration as that shown in FIG. 17B except that the direction in which the prisms are regularly disposed crosses the direction in which the prisms are regularly disposed in prism sheet 25a. Prism sheets 25a and 25b can enhance the directivity of the light diffused in diffuser plate 24.

In the first illumination optical device, the light that exits from the front surface of light guide plate 23 is diffused in diffuser plate 24 and then incident on optical element 20 via prism sheets 25a and 25b. The directivity of the light from diffuser plate 24 is enhanced in prism sheets 25a and 25b, and further enhanced in optical element 20. Therefore, when the first illumination optical device is viewed obliquely from any position in front of it, the viewer cannot recognize any exiting light.

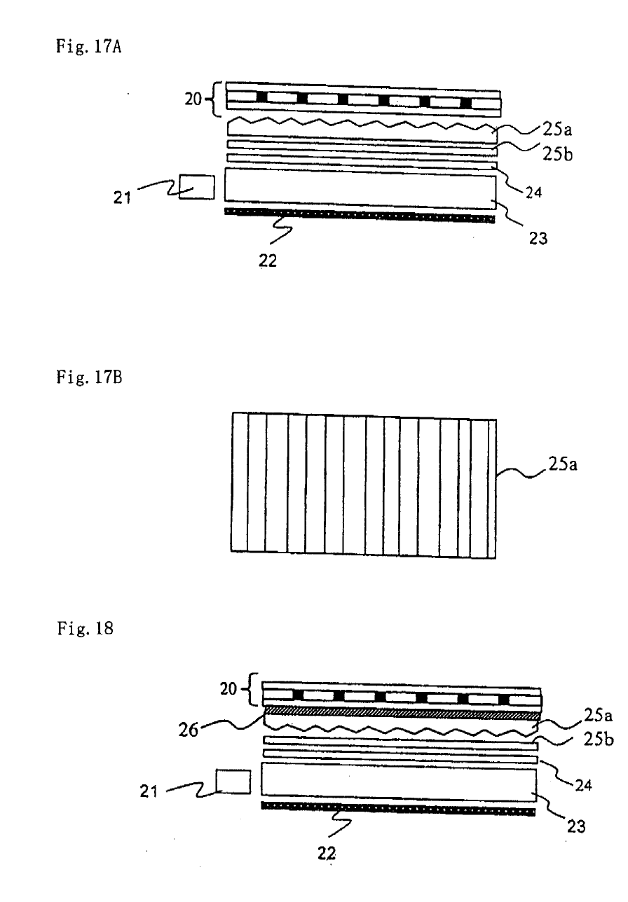

Furthermore, in the first illumination optical device, optical element 20 may be bonded to prism sheet 25a via transparent adhesive layer 26, as shown in FIG. 18. In this configuration, the loss due to surface reflection at the interface between optical element 20 and prism sheet 25a can be reduced, thus providing illumination light with higher brightness.

Although this exemplary embodiment has been described with reference to a cold cathode tube as the light source, the light source is not limited thereto. For example, a white LED or three-color LED may be used as the light source. Although this exemplary embodiment has been described with reference to a light source disposed on the side of the device, the form of the light source is not limited thereto. For example, a light source disposed immediately under the device may be used.

### [Second Illumination Optical Device]

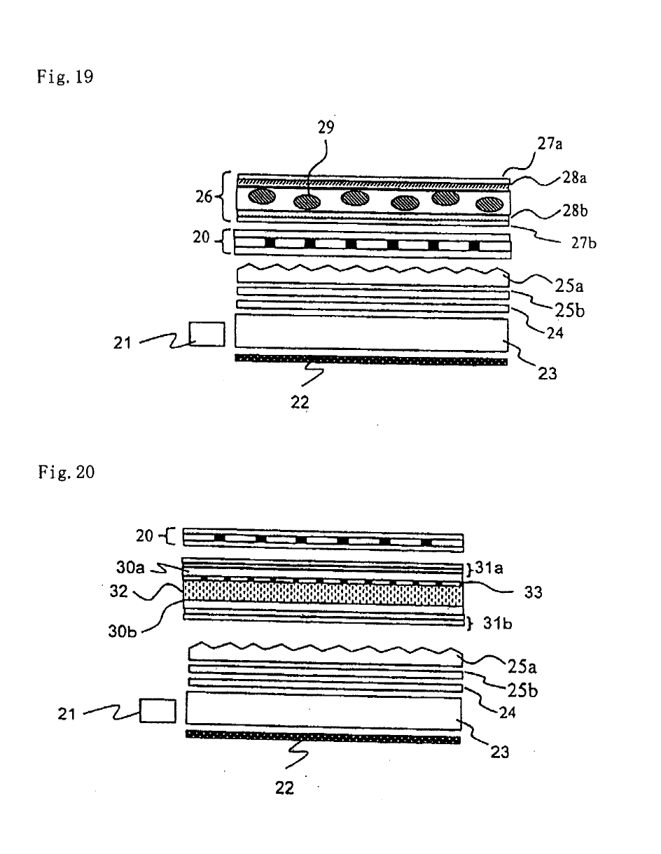

FIG. 19 shows the configuration of a second illumination optical device on which the optical element of the present invention is mounted. The second illumination optical device is similar to the first illumination optical device except that transmission/scattering switching element 26 is disposed on optical element 20. In FIG. 19, those having the same configurations as those in the first illumination optical device have the same reference characters. To avoid redundant description, description of the same configurations will be omitted.

Transmission/scattering switching element 26 is, for example, a PNLC (Polymer Network Liquid Crystal), and includes substrate 27a provided with transparent electrode 28a, substrate 27b provided with transparent electrode 28b, and polymer dispersed liquid crystal 29 sandwiched between substrates 27a and 27b.

When a voltage is applied between transparent electrodes 28a and 28b, the refractive index of the polymer chain coincides with that of polymer dispersed liquid crystal 29, so that transmission/scattering switching element 26 becomes transparent. In this transparent state, light from microlouver 20 passes straight through transmission/scattering switching element 26. On the other hand, when no voltage is applied between transparent electrodes 28a and 28b, the refractive index of the polymer chain does not coincide with that of polymer dispersed liquid crystal 29, so that the light from microlouver 20 is scattered when passing through transmission/scattering switching element 26. As described above, transmission/scattering switching element 26 is set to the mode in which it is transparent to light when a voltage is applied, or to the mode in which the light is scattered when no voltage is applied. Transmission/scattering switching element 26 may not be a PNLC but other devices, such as a PDLC (Polymer Dispersed Liquid Crystal), as long as they can be switched between the transparent mode and the scattering mode in response to voltage application.

In the transparent mode, optical element 20 constrains the extent of the exit angle. On the other hand, in the scattering mode, the extent of the exit angle constrained by optical element 20 increases. There is thus provided an illumination optical device capable of adjusting the exit angle by switching the transmission/scattering switching element.

In the second illumination optical device, transmission/scattering switching element 26 may be bonded to optical element 20 via a transparent adhesive layer. In such a configuration, the loss due to surface reflection at the interface between optical element 20 and transmission/scattering switching element 26 can be reduced, thus providing illumination light with higher brightness.

Although two prism sheets are used in the above example of the illumination optical device, one prism sheet may be used.

(2) Next, a description will be made of usage of the optical element of the present invention in which the optical element is directly attached to the surface of a display panel.

FIG. 20 shows the configuration of a display device in which the optical element of the present invention is provided on the display screen. Referring to FIG. 20, the display device includes an optical control element, an illumination optical device and optical element 20.

Optical element 20 is formed of any of the optical elements in the exemplary embodiments described above, and constrains the extent of the direction in which the light exits from the optical control element (internal light). The illumination optical device includes light source 21, reflective sheet 22, light guide plate 23, diffuser plate 24, and prism sheets 25a and 25b shown in FIG. 17A, and the light that has passed through prism sheets 25a and 25b illuminates the optical control element.

The optical control element has a structure in which liquid crystal layer 32 is sandwiched between two substrates 30a and 30b. Color filter 33 is formed on one of the surfaces of substrate 30a (the surface on the liquid crystal layer 32 side) and plate 31a consisting of polarization plate and phase difference plate is provided on the other surface. Plate 31b consisting of polarization plate and phase difference plate is provided on the surface of substrate 30b opposite to the surface on liquid crystal layer 32 side. In color filter 33, R (red), G (green) and B (blue) color filter elements are disposed in a matrix in the regions partitioned by a black matrix formed of light absorbing layers. The color filter elements correspond to respective pixels and are disposed at a fixed pitch. Liquid crystal layer 32 can be switched between a transparent mode and a light blocking mode on a pixel basis according to a control signal from a controller (not shown). By switching between these modes, incident light is spatially modulated.

In the display device shown in FIG. 20, the light that has passed through prism sheets 25a and 25b is incident on plate 31b consisting of polarization plate and phase difference plate. The light that has passed through plate 31b consisting of polarization plate and phase difference plate is incident on liquid crystal layer 32 via substrate 30b, where the light is spatially modulated on a pixel basis. The light that has passed through liquid crystal layer 32 (modulated light) sequentially passes through color filter 33 and substrate 30a and is incident on plate 31a consisting of polarization plate and phase difference plate. The light that has passed through plate 31a consisting of polarization plate and phase difference plate exits through optical element 20. Although FIG. 20 shows an example in which plates 31a and 31b consisting of polarization plate and phase difference plate are used as the optical control element, the optical control element of this exemplary embodiment is not limited thereto. For example, the optical control element may be formed of only a polarization plate.

In the display device described above, since optical element 20 constrains the direction in which light from plate 31a consisting of polarization plate and phase difference plate exits, the extent that is visible can be constrained. Therefore, even when the display device has a large-size screen, it is possible to prevent others from peeping at displayed information. A hard coat layer may be formed to prevent scratches on the surface of microlouver 20, or an antireflection layer may be formed to prevent reflection of ambient light.

Optical element 20 may be removably attached to the optical control element. In this case, attaching optical element 20 to the optical control element allows a display mode of a narrow field of view, while detaching optical element 20 from the optical control element allows a display mode of a wide field of view.

(3) Next, a display device in which the optical element of the present invention is mounted will be described.

### [First Display Device]

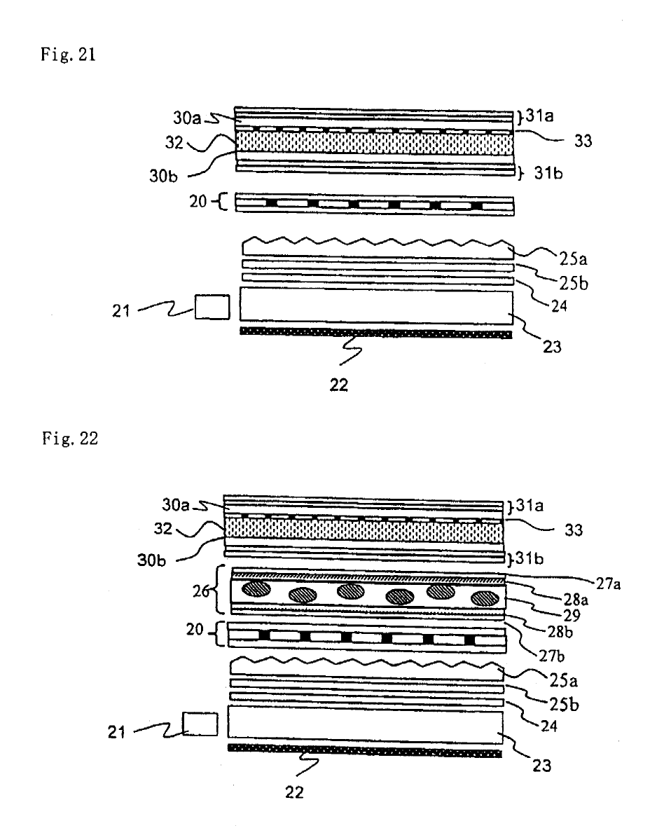

FIG. 21 shows the configuration of a first display device in which the optical element of the present invention is mounted. The first display device includes an optical control element, an illumination optical device that illuminates the optical control element, and optical element 20 provided between the optical control element and the illumination optical device.

Optical element 20 is formed of any of the optical elements in the exemplary embodiments described above, and constrains the extent of the direction in which light exits from the illumination optical device. The illumination optical device includes light source 21, reflective sheet 22, light guide plate 23, diffuser plate 24, and prism sheets 25a and 25b shown in FIG. 17A, and the light that has passed through prism sheets 25a and 25b illuminates the optical control element via optical element 20. The optical control element is the same as the optical control element shown in FIG. 20.

According to the first display device, since optical element 20 constrains the direction in which the light illuminating the optical control element exits, the extent that is visible can be constrained. Therefore, even when the display device has a large-size screen, it is possible to prevent others from peeping at displayed information.

In the configuration shown in FIG. 21, optical element 20 may be attached to the optical control element via a transparent adhesive layer. In such a configuration, the loss due to surface reflection at the interface between optical element 20 and the optical control element can be reduced, thus providing illumination light with higher brightness.

### [Second Display Device]

FIG. 22 shows the configuration of a second display device in which the optical element of the present invention is mounted. The second display device includes an optical control element, an illumination optical device that illuminates the optical control element, and optical element 20 and transmission/scattering switching element 26 provided between the optical control element and the illumination optical device.

The optical element is formed of any of the optical elements in the exemplary embodiments described above, and constrains the extent of the direction in which light exits from the illumination optical device. Illumination optical device includes light source 21, reflective sheet 22, light guide plate 23, diffuser plate 24, and prism sheets 25a and 25b shown in FIG. 17A, and light that has passed through prism sheets 25a and 25b illuminates the optical control element via optical element 20. The optical control element is the same as the optical control element shown in FIG. 20. Transmission/scattering switching element 26 is the same as that shown in FIG. 19.

In the second display device, when transmission/scattering switching element 26 is set to the transparent mode, optical element 20 constrains the extent of the exit angle in the display panel. In this case, since the extent that is visible in the display screen of the optical control element is constrained, it is possible to prevent peeping. On the other hand, when transmission/scattering switching element 26 is set to the scattering mode, the extent of the exit angle constrained by optical element 20 increases. In this case, since the extent that is visible increases, a plurality of viewers can simultaneously look at the display screen.

In the configuration shown in FIG. 22, optical element 20 may be attached to substrate 27b of transmission/scattering switching element 26 via a transparent adhesive layer, and/or the optical control element may be attached to substrate 27a of transmission/scattering switching element 26 via a transparent adhesive layer. In such a configuration, loss due to surface reflection at the interface between optical element 20 and substrate 27b and/or loss due to surface reflection at the interface between the optical control element and substrate 27a can be reduced, thus providing illumination light that has higher brightness.

### [Third Display Device]

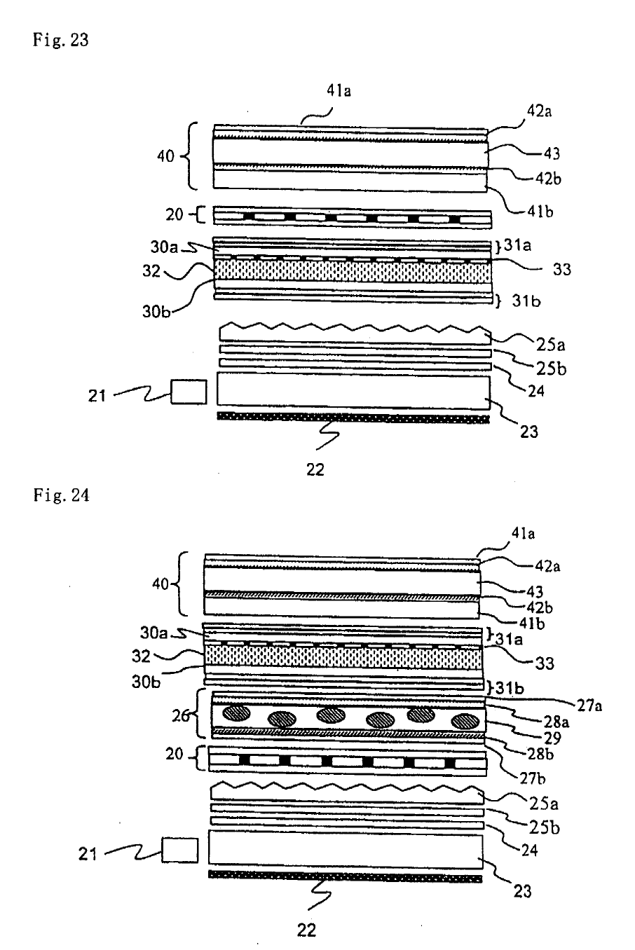

FIG. 23 shows the configuration of a third display device in which the optical element of the present invention is mounted. The third display device includes an illumination optical device, an optical control element, optical element 20, and input device 40 stacked in this order.

Optical element 20 is formed of any of the optical elements in the exemplary embodiments described above, and constrains the extent of the direction of the light that exits from the optical control element (internal light). The illumination optical device includes light source 21, reflective sheet 22, light guide plate 23, diffuser plate 24, and prism sheets 25a and 25b shown in FIG. 17A, and the light that has passed through prism sheets 25a and 25b illuminates the optical control element. The optical control element is the same as the optical control element shown in FIG. 20.

Input device 40 is a so-called touch panel, and includes transparent electrode 42a formed on transparent substrate 41a and transparent electrode 42b formed on transparent substrate 41b, the two transparent electrodes facing each other via spacer 43. The touch panel is not limited to the resistive film type shown in FIG. 23, but may be existing types, such as a capacitive coupling type. According to such a touch panel-type input device 40, information on the position on the display panel is inputted based on local variation in pressure or current.

According to the third display device, since optical element 20 constrains the direction in which light exits from the optical control element, the extent that is visible can be constrained. Therefore, even when the display device has a large-size screen, it is possible to prevent others from peeping at displayed information. Such a display device is especially effective when personal or confidential information is inputted to an ATM terminal or a commuter pass issuing machine from the information protection point of view.

In the configuration shown in FIG. 23, optical element 20 may be attached to transparent substrate 41b of input device 40 via a transparent adhesive layer and/or optical element 20 may be attached to the optical control element via a transparent adhesive layer. In such a configuration, loss due to surface reflection at the interface between optical element 20 and transparent substrate 41b and/or loss due to surface reflection at the interface between optical element 20 and the optical control element can be reduced, thus providing a display screen that has higher brightness.

Optical element 20 may be disposed on input device 40. In this case, optical element 20 may be attached to transparent substrate 41a of input device 40 via a transparent adhesive layer. In such a configuration, loss due to surface reflection at the interface between optical element 20 and transparent substrate 41a can be reduced, thus providing a display screen that has higher brightness.

Alternatively, optical element 20 may be provided between the optical control element and the illumination optical device. In this case, optical element 20 may be attached to prism sheet 25a or the optical control element via a transparent adhesive layer. In such a configuration, loss due to surface reflection at the interface between optical element 20 and prism sheet 25a or loss due to surface reflection at the interface between the optical element 20 and the optical control element can be reduced, thus providing illumination light that has higher brightness.

### [Fourth Display Device]

FIG. 24 shows the configuration of a fourth display device in which the optical element of the present invention is mounted. The fourth display device includes an illumination optical device, optical element 20, transmission/scattering switching element 26, an optical control element, and input device 40 stacked in this order.

Optical element 20 is formed of any of the optical elements in the exemplary embodiments described above, and constrains the extent of the direction of light that exits from the illumination optical device. The illumination optical device includes light source 21, reflective sheet 22, light guide plate 23, diffuser plate 24, and prism sheets 25a and 25b shown in FIG. 17A, and the light that has passed through prism sheets 25a and 25b illuminates the optical control element via optical element 20 and transmission/scattering switching element 26. Transmission/scattering switching element 26 is the same as that shown in FIG. 19. The optical control element is the same as that shown in FIG. 20. Input device 40 is the same as that shown in FIG. 23.

In the fourth display device, in the transparent mode, optical element 20 constrains the extent of the exit angle in the display panel. In this case, since the extent that is visible in the display screen of the optical control element decreases, it is possible to prevent peeping. On the other hand, in the scattering mode, the extent of the exit angle constrained by optical element 20 increases. In this case, since the extent that is visible increases, a plurality of viewers can simultaneously look at the display screen.

The configuration shown in FIG. 24 may include a controller that receives inputs via input device 40 to control transmission/scattering switching element 26, and a storage device that stores information in advance, such as advertisements. In this case, when no information is inputted via input device 40, the controller sets transmission/scattering switching element 26 to the scattering mode and controls modulation performed in the optical control element to display the information stored in the storage device, while when information is inputted via input device 40, the controller sets transmission/scattering switching element 26 to the transparent mode and controls modulation performed in the optical control element to display the inputted information. According to such a configuration, for example in an ATM terminal, before information is inputted, advertisement information is displayed on the screen in the display mode of a wide field of view, and after personal information is inputted, the inputted information (personal information) can be displayed in the display mode of a narrow field of view.

Optical element 20 may be attached to transmission/scattering switching element 26 via a transparent adhesive layer, and transmission/scattering switching element 26 may be attached to the optical control element via a transparent adhesive layer. In such a configuration, loss due to surface reflection at the interface between optical element 20 and transmission/scattering switching element 26 and the loss due to surface reflection at the interface between transmission/scattering switching elements 26 and the optical control element can be reduced, thus providing illumination light having higher brightness.

The optical element of the present invention can be easily applied to display devices of information processing terminals, such as ATM terminals, mobile phones, notebook personal computers and PDAS.

Examples of the display device of an ATM terminal to which the optical element of the present invention is applied may be the third and fourth display devices described above. When the third or fourth display device is applied to the display device of an ATM terminal, it is possible to prevent peeping at displayed personal information and display a high-quality image. In this case, by employing any of the structures shown in FIGS. 16A to 16D (two-dimensional louver structures) as the optical element, the extent that is visible in the up/down direction as well as the right/left direction decreases, thus providing a screen more difficult for others to peep at. Furthermore, in the fourth display device, the narrow field of view prevents peeping when information is being inputted, while at other times, the display mode is switched to the wide field of view and advertisement information is displayed, thereby allowing effective advertisement using the ATM terminal.

Examples of a mobile information processing terminal, such as, a mobile phone, a notebook personal computer and a PDA, to which the optical element of the present invention can be applied may be the first and second display devices described above. In an information processing terminal, a controller receives inputs from input devices, such as a mouse and a keyboard, to display necessary information on the display device. In this case, it is also possible to prevent peeping at displayed information and display a high-quality image. Furthermore, the information processing terminal can be provided with an input device (touch panel) as described previously with reference to the third or fourth display device.

The electronic instrument according to the present invention includes the various information processing terminals described above.

While exemplary embodiments of the present invention have been described using specific terms, such description is for illustrative purposes only, and it is to be understood that changes and variations may be made without departing from the spirit or scope of the following claims.

What is claimed is:

1. An optical element comprising:
a microlouver including transparent layers and light absorbing layers alternately disposed, the light absorbing layers constraining the extent of the direction in which the light passing through the transparent layers exits; and
a diffusion layer provided on the microlouver,
wherein the angle of the field of view of the light passing thorough the optical element changes in such a way that the angle of the field of view is smaller in the peripheral area of the optical element than that in the central area of the optical element.

2. The optical element according to claim 1, wherein the width of the transparent layer disposed between adjacent light absorbing layers is smaller in the peripheral area of the optical element than that in the central area of the optical element.

3. The optical element according to claim 1, wherein the width of the transparent layer disposed between adjacent light absorbing layers remains unchanged across the surface of the optical element.

4. An optical element comprising:
a microlouver including transparent layers and light absorbing layers alternately disposed, the light absorbing layers constraining the extent of the direction in which the light passing through the transparent layers exits; and
a diffusion layer provided on the microlouver,
wherein the diffusion power of the diffusion layer is lower in the peripheral area of the optical element than that in the central area of the optical element.

5. The optical element according to claim 4, wherein the angle of the field of view of the light passing through the optical element changes in one direction on the optical element.

6. The optical element according to claim 4, wherein the angle of the field of view of the light passing through the optical element changes at least in two intersecting directions on the optical element.

7. An illumination optical device comprising:
the optical element according to claim 1; and
a planar light source provided on the rear side of the optical element.

8. The illumination optical device according to claim 7 further comprising a transmission/scattering switching element on which light from the optical element is incident,
wherein the transmission/scattering switching element can be switched between a transparent mode in which incident light exits, as is, and a scattering mode in which incident light is scattered and exits as diffused light.

9. An illumination optical device comprising:
the optical element according to claim 4; and
a planar light source provided on the rear side of the optical element.

10. The illumination optical device according to claim 9 further comprising a transmission/scattering switching element on which light from the optical element is incident,
wherein the transmission/scattering switching element can be switched between a transparent mode in which incident light exits, as is, and a scattering mode in which incident light is scattered and exits as diffused light.

11. A display device comprising:
the optical element according to claim 1;
a display panel on which pixels are disposed; and
a planar light source for illuminating the display panel,
wherein light from the planar light source illuminates the display panel via the optical element.

12. The display device according to claim 11 further comprising an input device provided on the display screen side of the display panel,
wherein the input device receives inputted information about a position on the display panel based on local variation in pressure or current.

13. A display device comprising:
the optical element according to claim 4;
a display panel on which pixels are disposed; and
a planar light source for illuminating the display panel,
wherein light from the planar light source illuminates the display panel via the optical element.

14. The display device according to claim 13 further comprising an input device provided on the display screen side of the display panel,
wherein the input device receives inputted information about a position on the display panel based on local variation in pressure or current.

15. A display device comprising:
the optical element according to claim 1; and
a display panel on which pixels are disposed;
wherein light from the display device exits via the optical element.

16. The display device according to claim 15, wherein the optical element is removably provided on the display screen of the display panel.

17. The display device according to claim 15 further comprising an input device provided on the optical element,
wherein the input device receives inputted information about a position on the display panel based on local variation in pressure or current.

18. A display device comprising:
the optical element according to claim 4; and
a display panel on which pixels are disposed;
wherein light from the display device exits via the optical element.

19. The display device according to claim 18, wherein the optical element is removably provided on the display screen of the display panel.

20. The display device according to claim 18 further comprising an input device provided on the optical element,
wherein the input device receives inputted information about a position on the display panel based on local variation in pressure or current.

21. A display device comprising:
the optical element according to claim 1;
a display panel on which pixels are disposed;
a planar light source for illuminating the display panel; and
a transmission/scattering switching element on which light from the planar light source is incident via the optical element, the transmission/scattering switching element capable of being switched between a transparent mode in which incident light exits, as is, and a scattering mode in which incident light is scattered and exits as diffused light,
wherein light that exits from the transmission/scattering switching element illuminates the display panel.

22. The display device according to claim 21 further comprising an input device provided on the display screen side of the display panel,
wherein the input device receives inputted information about a position on the display panel based on local variation in pressure or current.

23. A display device comprising:
the optical element according to claim 4;
a display panel on which pixels are disposed;
a planar light source for illuminating the display panel; and
a transmission/scattering switching element on which light from the planar light source is incident via the optical element, the transmission/scattering switching element capable of being switched between a transparent mode in which incident light exits, as is, and a scattering mode in which incident light is scattered and exits as diffused light,
wherein the light that exits from the transmission/scattering switching element illuminates the display panel.

24. The display device according to claim 23 further comprising an input device provided on the display screen side of the display panel,
wherein the input device receives inputted information about a position on the display panel based on local variation in pressure or current.

25. An electronic instrument comprising the display device according to claim 21,
wherein the transmission/scattering switching element is switched between the transparent mode and the scattering mode based on an externally inputted signal.

26. An electronic instrument comprising the display device according to claim 23,
wherein the transmission/scattering switching element is switched between the transparent mode and the scattering mode based on an externally inputted signal.
